(19) United States
(12) Patent Application Publication
(10) Pub. No.: US 2006/0030252 A1
(43) Pub. Date: Feb. 9, 2006

(54) Poultry shield

(75) Inventor: Frank R. Tiemann, Madison Lake, MN (US)

Correspondence Address: NIKOLAI & MERSEREAU, P.A., 900 SECOND AVENUE SOUTH, SUITE 820, MINNEAPOLIS, MN, 55402, US

(73) Assignee: NIFTY HOME PRODUCTS, INC., Madison Lake, MN (US)

(21) Appl. No.: 11/179,191

(22) Filed: Jul. 12, 2005

Related U.S. Application Data
(60) Provisional application No. 60/589,288, filed on Jul. 20, 2004.

(51) Int. Cl. A22C 25/06

(52) U.S. Cl. 452/185

(57) ABSTRACT

The present invention, in one embodiment, is a poultry shield specially configured to fill and seal the chest cavity opening in a poultry bird such as turkey, chicken, goose, duck, etc. For example, once the chest cavity of the bird is filled with stuffing, the poultry shield, which is generally pie-slice-shaped, is inserted into the chest cavity opening such that the front tip of the shield is under the most rearward tip of the bird's chest plate, the rounded back portion of the shield abuts against the most forward portion of the bird's rump structure, and the skin defining the chest cavity opening is tucked around the shield. To maintain the shield in the aforementioned sealing position, the bird's legs are placed over the shield and tucked under a wire clip attached to the shield. The bird's chest cavity is now sufficiently sealed to allow the stuffed bird to be cooked within an oven without overly drying the stuffing within the bird's chest cavity. Thus, because of the poultry shield of the present invention, it is no longer necessary to lace the chest cavity opening closed to seal the chest cavity to prevent overly drying the stuffing within the bird.

### FIELD OF THE INVENTION

The present invention relates to apparatus and methods for preparing food. More specifically, the present invention relates to apparatus and several methods of preparing poultry.

### BACKGROUND OF THE INVENTION

It is common to fill the chest cavity of a poultry bird with a bread-based stuffing when preparing the bird for human consumption. To adequately cook the bird and stuffing and reduce the chances of contracting food poisoning, the bird must be cooked within an oven at high temperatures for a relatively long period of time. This is especially the case when the bird is a turkey or other large poultry bird.

Stuffing tends to become dry and less palatable when exposed to extended periods of high heat. Consequently, cooks often seal the stuffing within the chest cavity by lacing the chest cavity closed. This prevents moisture from leaving the stuffing and helps to keep the stuffing palatable. Unfortunately, lacing closed the chest cavity of a poultry bird is messy and time consuming.

There is a need in the art for a device that can be used to quickly seal the chest cavity of a poultry bird. There is also a need in the art for a method of quickly sealing the chest cavity of a poultry bird.

### BRIEF SUMMARY OF THE INVENTION

The present invention, in one embodiment, is a poultry shield for sealing a chest cavity opening of a poultry bird. The poultry shield comprises a generally pie-slice-shaped shield portion, a pair of arcuate wings, a pair of holes in the shield portion, a pair of tabs, and a clip. The generally pie-slice-shaped shield portion includes a generally truncated tip with first and second ends, an arcuate back portion with first and second ends, and two generally straight sides that converge from the ends of the arcuate back portion to the ends of the truncated tip. Each of the pair of arcuate wings lies adjacent to the generally straight sides and extends downward and outward from the shield portion. The pair of holes is in the pie-shaped shield portion near the arcuate back portion. The holes are equally offset from a longitudinal centerline of the shield portion. The pair of tabs extends generally downward from the pair of holes. The tabs each have a pivot hole. The clip has a pair of fee ends for being received in the pivot holes. The clip extends upward through the holes in the shield portion and extends along the shield portion towards the truncated tip. The end of the clip near the generally truncated tip forms a pair of horizontal curves and a rearward directed center curve.

The present invention also offers a new method of sealing a chest cavity opening of a poultry bird after the bird has been stuffed, the chest cavity opening existing between a rearward portion of a breast plate of the bird and a forward portion of a rump portion of the bird. Specifically, the method comprises obtaining a generally triangular-shaped poultry shield, wherein the poultry shield has a front tip, an arcuate back portion that is wider than the tip and opposite the tip, and a pair of sides that converge towards the tip from the ends of the back portion. The tip of the poultry shield is then inserted into the chest cavity opening such that the tip is positioned under the rearward portion of the breastplate. The back portion is then inserted into the chest cavity opening such that the back portion abuts the forward portion of the rump. The skin of the bird defining the chest cavity opening is then tucked into a groove formed between the shield portion and a wing portion extending downwardly and outwardly from the shield portion. Finally, the legs of the bird are placed over the top of the shield portion and under a clip attached to the shield portion.

While multiple embodiments are disclosed, still other embodiments of the present invention may become apparent to those skilled in the art from the following detailed description, which shows and describes a preferred embodiment of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a top view of the poultry shield;

FIG. 2 is bottom view of the poultry shield;

FIG. 3 is a sectional elevation of the poultry shield taken along section line AA in FIGS. 1 and 2;

FIG. 4 is a front elevation of the poultry shield as viewed from the direction of arrow B in FIG. 2;

FIG. 5 is a side elevation of the poultry shield as viewed from the direction of arrow C in FIG. 1;

FIG. 6 is a perspective view of a poultry bird with its chest cavity filled with stuffing;

FIG. 7 is a perspective view of the poultry shield being installed in the chest cavity opening; and

FIG. 8 is a perspective view of the poultry shield fully installed in the chest cavity opening.

### DETAILED DESCRIPTION

The poultry shield of the subject invention is specially configured to cover and seal the chest cavity opening in a poultry bird such as turkey, chicken, goose, duck, etc. As will be described in detail below, once the chest cavity of the bird is filled with moist, bread-based stuffing, the poultry shield, which, in one embodiment, is generally pie-slice-shaped, is inserted into the chest cavity opening such that the front tip of the shield is under the most rearward rib of the bird's chest plate, the rounded back portion of the shield abuts against the most forward portion of the bird's rump structure, and the skin defining the chest cavity opening is tucked around the shield. To maintain the shield in the aforementioned sealing position, the bird's legs are placed over the shield and tucked under a wire clip attached to the shield. The bird's chest cavity is now sufficiently sealed to allow the stuffed bird to be cooked within an oven without overly drying the stuffing within the bird's chest cavity. Thus, because of the poultry shield of the present invention, it is no longer necessary to lace the chest cavity opening closed to seal the chest cavity to prevent overly drying the stuffing within the bird.

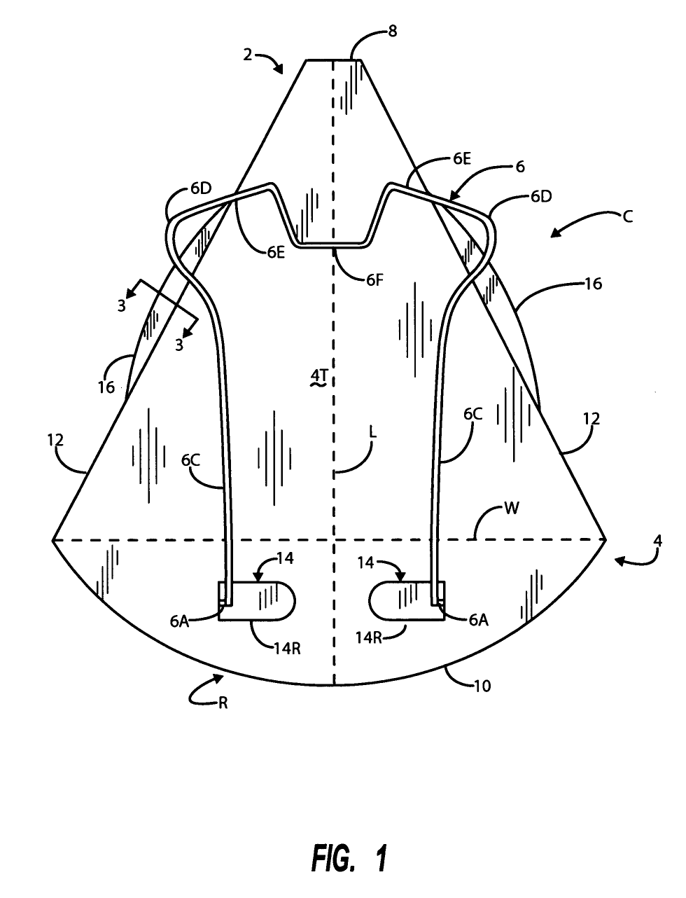

For a detailed discussion of the poultry shield of the subject invention, reference is now made to FIG. 1, which is a top view of the poultry shield 2. As shown in FIG. 1, in one embodiment, the poultry shield 2 includes a generally planar shield portion 4 and a clip 6 attached to the shield portion 4.

As indicated in FIG. 1, in one embodiment, the shield portion 4 is generally triangular shaped with a truncated tip 8. In other words, the shield portion has an arcuate flange 10 and two side edges 12 that converge from the ends of the arcuate flange 10 to the ends of the truncated tip 8. The shield portion includes a top surface 4T and a bottom surface 4B (shown in later figures). Said flange depends from a base of the triangular shaped segment.

As illustrated in FIG. 1, in one embodiment, two elongated and rounded holes 14 are cut in the shield portion 4. In one embodiment, the holes 14 are generally equally offset from the longitudinal centerline of the shield portion 4. As shown in FIG. 1, the clip 6 projects up through the holes 14 and extends towards the tip 8 of the shield portion 4.

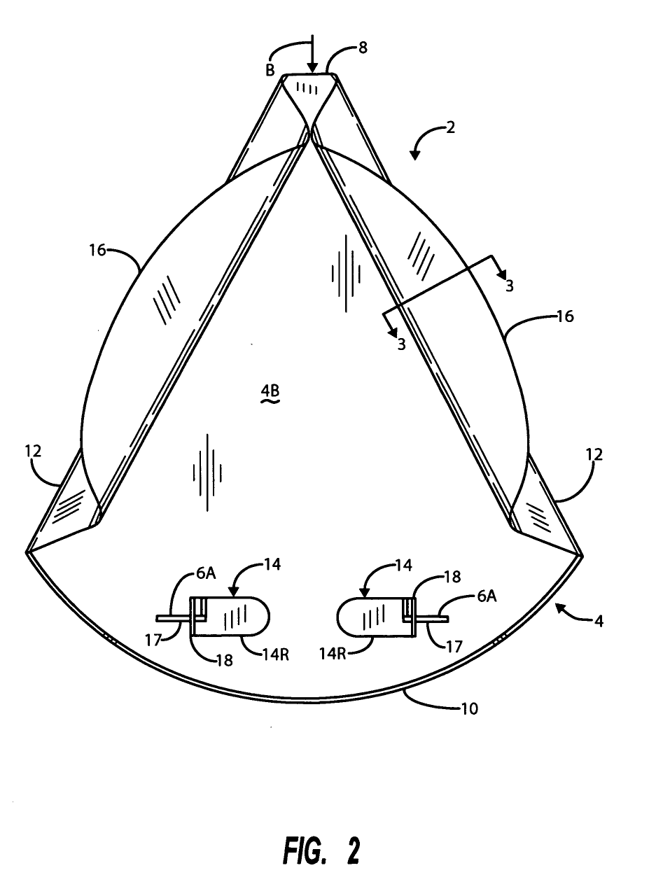

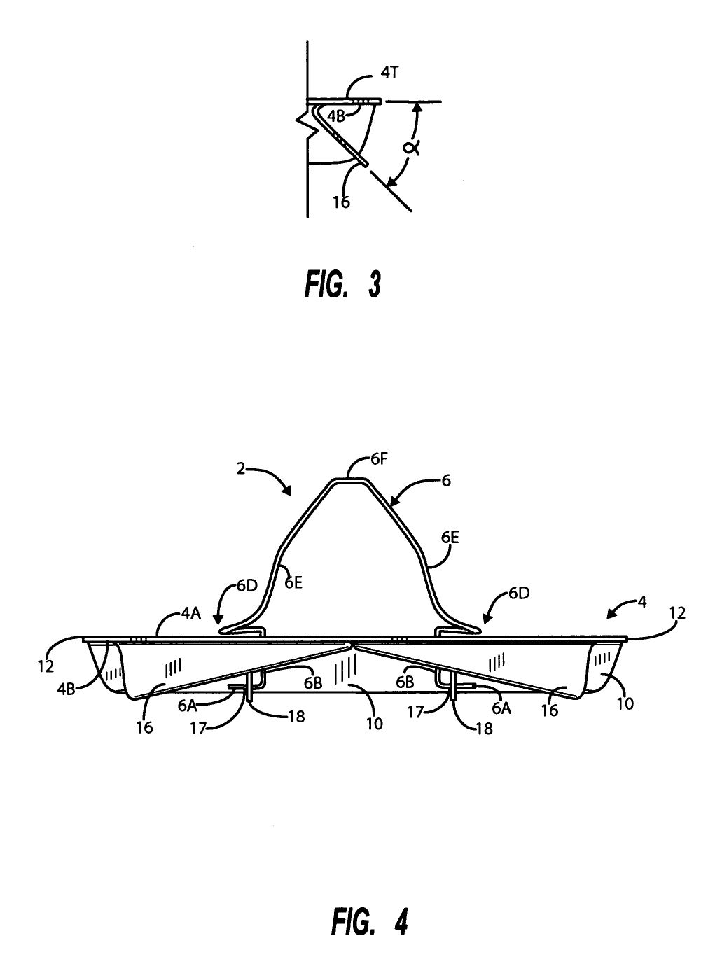

As indicated in FIG. 1 and more clearly shown in FIG. 2, which is a bottom view of the poultry shield 2, the shield portion 4 includes arcuate wings 16 that extend outwardly and downwardly from the bottom surface 4B of the shield portion 4. In other words, as illustrated in FIG. 3, which is a partial sectional elevation taken along section line AA in FIGS. 1 and 2, each arcuate wing 16 extends from the bottom surface 4B of the shield portion 4 such that the wing 16 forms, in one embodiment, an acute angle, α, between the outer edge of the bottom surface 4B and the upper surface of the wing 16. In one embodiment, the angle α is between about 10° and about 80°. In yet another embodiment, the angle α is between about 20° and about 70°. In another embodiment, the angle α is between about 30° and about 60°.

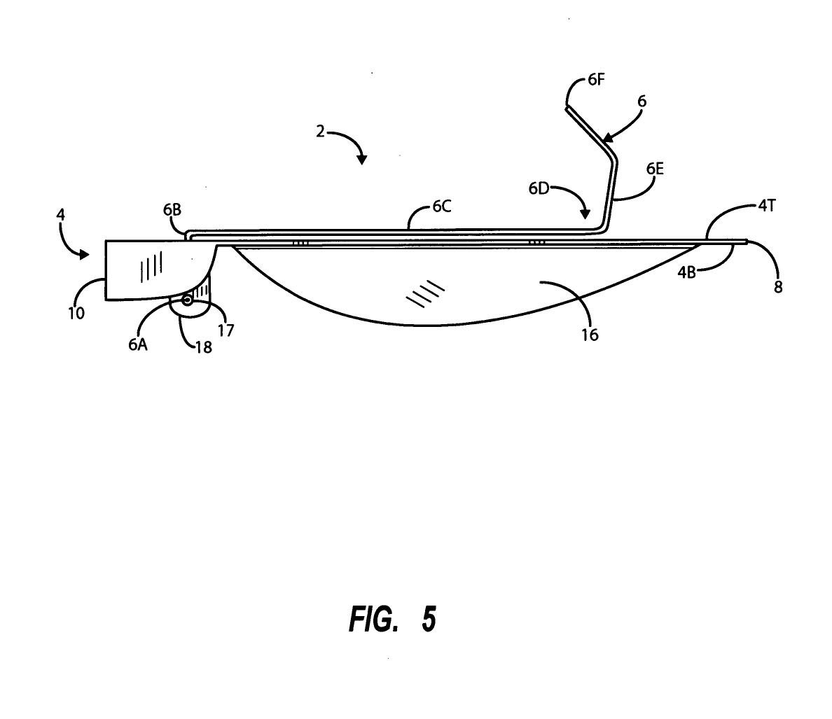

As shown in FIG. 2, the clip 6 has two ends 6A that each extend through a hole 17 in a tab 18. Tabs 18 comprise the portions of shield 4 that are cut and bent out of the plane of the shield in forming the holes 14. The holes 17 and tabs 18 are more clearly illustrated in FIGS. 4 and 5, which are, respectively, a front elevation of the poultry shield 2 as viewed from the direction of arrow B in FIG. 2 and a side elevation of the poultry shield 2 as viewed from the direction of arrow C in FIG. 1. As indicated in FIGS. 4 and 5, each end 6A of the clip 6 is pivotally mounted in a tab hole 17. However, as can be understood from FIGS. 1 and 5, in one embodiment, the clip 6 has limited ability to pivot within the tab holes 17. This is because the vertical clip portions 6B, which extend through the holes 14, will abut against the rearmost edges 14R of the holes 14 when the clip 6 is pivoted within the tab holes 17 any more than minimally. This feature provides the clip 6 with the resistance that allows it to clip a bird's legs between the clip 6 and the top surface 4T of the shield portion 4, as described below.

As indicated by the dashed lines in FIG. 1, in one embodiment intended for poultry birds up to 30 pounds, the shield portion 4 has a length L (measured from the truncated tip 8 to the arcuate back portion 10) of approximately 6 inches and a width (measured between the two ends of the arcuate back portion 10) of approximately 5 inches. In this embodiment, the arcuate back portion 10 has a radius of approximately 3 inches. These dimensions may vary for other embodiments of the poultry shield 2 configured for poultry birds larger than 30 pounds or poultry birds significantly smaller than 30 pounds.

In one embodiment, the shield portion 4 is stamped from sheet metal and the clip 6 is formed from wire stock. The shield portion 4 and clip 6 are then coated with a chrome or other food safe finish. In one embodiment, the shield portion 4 and the clip 6 are made of stainless steel. In other embodiments, the shield may be made of other food and heat compatible materials. For example, the shield may be made of ceramic, glass or a suitable high temperature, food-grade plastic material.

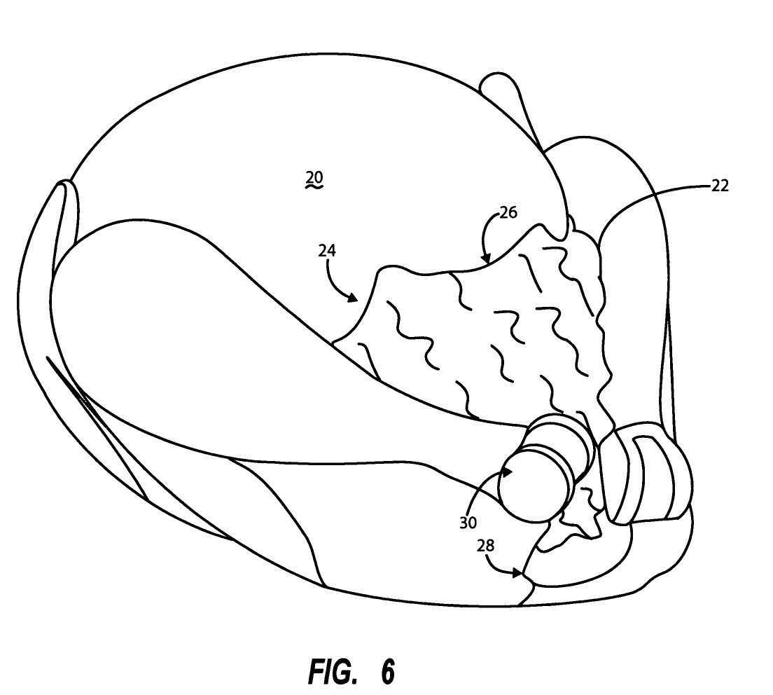

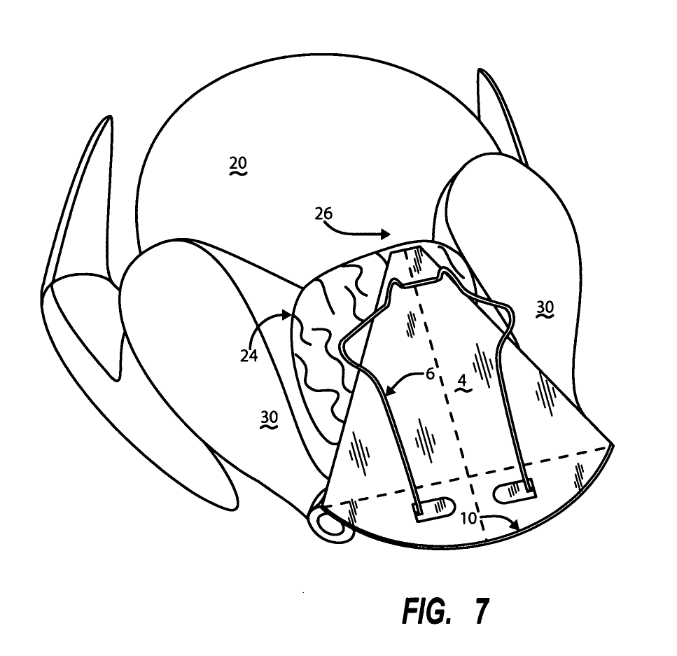

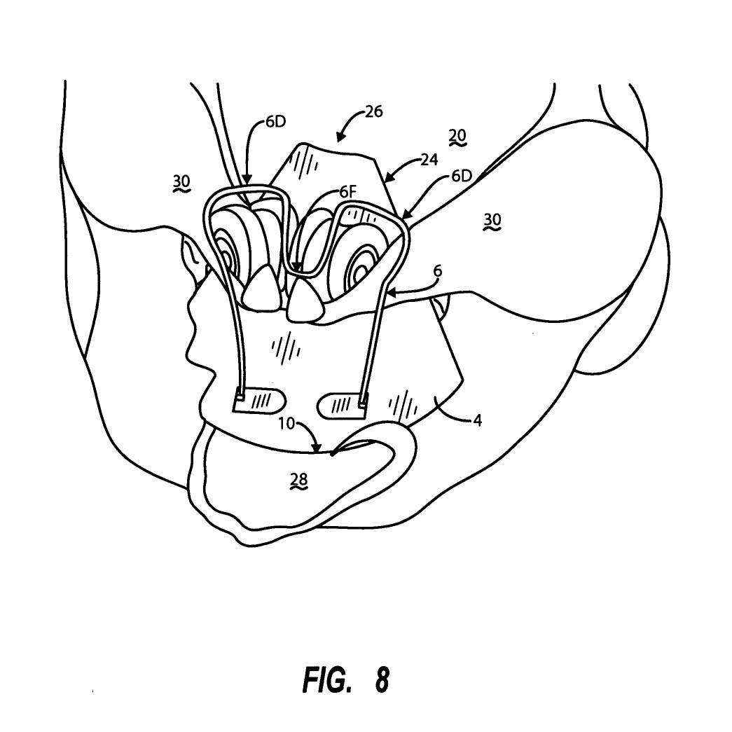

For a discussion of the method of utilizing the poultry shield 2 of the subject invention, reference is now made to FIGS. 6-8. FIG. 6 is a perspective view of a poultry bird 20 with its chest cavity filled with stuffing 22. FIG. 7 is a perspective view of the poultry shield 2 being installed in the bird's chest cavity opening 24. FIG. 8 is a perspective view of the poultry shield 2 fully installed in the bird's chest cavity opening 24.

As indicated in FIG. 6, the chest cavity of the poultry bird 20 has been filed with stuffing 22 to the point that the stuffing 22 is visible in the chest cavity opening 24 that exists in the bird 20 between its chest plate tip 26 and its rump structure 28. At this point, prior to the development of the poultry shield 2 of the subject invention, a cook would have to lace closed the sides of the chest cavity opening 24 in order to prevent the stuffing 22 from overly drying during the cooking process. Lacing the chest cavity opening 24 is messy and time consuming. Fortunately, as can be understood from the following discussion, the poultry shield 2 eliminates the need for lacing.

As indicated in FIGS. 2, 4 and 5, in one embodiment, the arcuate back portion 10 is a flange-like portion that extends generally perpendicularly downward from the bottom surface 4B of the shield portion 4. In other embodiments, the arcuate back portion 10 still extends downward from the bottom surface 4B of the shield portion 4, but at an angle relative to the bottom surface 4B that is not generally perpendicular.

For a general discussion of the configuration of the clip 6, reference is now made to FIGS. 1, 4 and 5. As indicated in FIGS. 1, 4 and 5, the clip 6 is generally u-shaped and has a pair of generally straight to ever-so-slightly curved portions 6C that transition into a pair of horizontally curved leg portions 6D. The horizontally curved portions 6D transition into a pair of generally straight vertical sections 6E, which transitions into a rounded or squared rearward oriented hooked section 6F that is generally centered over the longitudinal center line of the shield portion 4.

As shown in FIG. 7, to install the poultry shield 2 in a stuffed poultry bird 20, the most rearward portion of the bird's chest plate (i.e., the chest plate tip 26) is pulled upwards to accommodate the shield portion 4 of the poultry shield 2. As indicated in FIG. 8, the poultry shield 2 is then inserted into the chest cavity opening 24 such that the truncated tip 8 of the shield portion 4 is under the chest plate tip 26, the arcuate back portion 10 abuts against the most forward portion of the bird's rump structure 28, and the skin defining the chest cavity opening 24 is tucked around the shield portion 4. As can be understood from FIGS. 1-5 and 8, the skin defining the chest cavity opening 24 is tucked in the groove between the bottom surface 4B of the shield portion 4 and the top surface of the arcuate wings 16. This arrangement helps to seal closed the chest cavity opening 24. Also, the arcuate wings 16 help to retain the shield portion 4 within the chest cavity opening 24.

As shown in FIG. 8, to maintain the shield portion 4 in the aforementioned sealing position, the bird's legs 30 are placed over the shield portion 4 and tucked under the clip 6. As indicated in FIG. 8, the horizontally curved portions 6D and the rounded or squared rearward oriented hooked section 6F facilitate the clip's ability to hold the bird's legs 30.

As shown in FIG. 8, the bird's chest cavity opening 24 is now sufficiently sealed to allow the stuffed bird to be cooked within an oven without overly drying the stuffing 22 within the bird's chest cavity. Thus, because of the poultry shield 2 of the present invention, it is no longer necessary to lace the chest cavity opening 24 closed to seal the chest cavity to prevent overly drying the stuffing within the bird 20.

Although the present invention has been described with reference to preferred embodiments, persons skilled in the art will recognize that changes may be made in form and detail without departing from the spirit and scope of the invention.

I claim:

1. A poultry shield for covering a chest cavity opening of a poultry bird following filling of the chest cavity with stuffing comprising:
a planar, generally triangular shaped segment with a truncated vertex and an arcuate flange depending from a base of the triangular shaped segment out of the plane of the triangular shaped segment.

2. The poultry shield in claim 1 and further including:
a pair of apertures formed through a thickness dimension of the arcuate flange and having normally projecting tabs adjacent one end of each of the pair of apertures.

3. The poultry shield of claim 1 and further including a generally unshaped wire clip member with opposed legs of the clip member extending through the pair of apertures and pivotally connected to the tabs.

4. The poultry shield as in claim 3 and further including arcuate wings depending along opposed side edges of the triangular shaped segment.

5. The poultry shield as in claim 4 wherein the arcuate wings are inclined at an acute angle to the plane of the triangular segment.

6. The poultry shield as in claim 5 wherein the acute angle is in a range between about 10° and about 80°.

7. The poultry shield as in claim 4 wherein the triangular shaped segment, the arcuate flange and the arcuate wings are integrally formed from one of stainless steel and high melting point, food grade plastic and glass.

8. The poultry shield as in claim 3 wherein pivotal movement of the clip member is limited by engagement of the clip member with a side of said pair of apertures.
